(19) United States
(12) Patent Application Publication
(10) Pub. No.: US 2014/0219183 A1
(43) Pub. Date: Aug. 7, 2014

(54) Method, System and Apparatus for Indicating Message Type

(71) Applicants: Hui Xu, Shenzhen (CN); Chuanxi Wu, Shenzhen (CN); Qingbo Sun, Shenzhen (CN)

(72) Inventors: Hui Xu, Shenzhen (CN); Chuanxi Wu, Shenzhen (CN); Qingbo Sun, Shenzhen (CN)

(73) Assignee: ZTE CORPORATION, Shenzhen City, Guangdong Province (CN)

(21) Appl. No.: 13/636,335

(22) PCT Filed: Nov. 18, 2011
(86) PCT No.: PCT/CN2011/082474

§ 371 Date: Sep. 20, 2012

(30) Foreign Application Priority Data
Oct. 17, 2011 (CN) 201110314769.7

(51) Int. Cl. H04L 5/00

(52) U.S. Cl. CPC H04L 5/0053
USPC 370/329

(57) ABSTRACT

The present invention discloses a method for indicating a message type, including: setting a message type identification in a transmitted control plane signaling; a network node which receives the control plane signaling, according to the message type identification, identifying whether user plane data are contained in the control plane signaling, and transmitting the user plane data to a user equipment or other network nodes or a machine type communication server (MTC Server) through the control plane signaling when confirming that the control plane signaling contains the user plane data; and the user equipment or the MTC Server identifying whether the control plane signaling contains the user plane data, and retrieving the user plane data therefrom when the control plane signaling contains the user plane data. The present invention further provides a system and apparatus for indicating a message type.

### TECHNICAL FIELD

The present invention relates to the mobile communication technology, and in particular, to a method, system and apparatus for indicating a message type.

### BACKGROUND OF THE RELATED ART

The machine to machine (M2M) refers to all technologies and means for establishing the connection between the machines. The M2M idea appears in the nineties last century, but it only remained at theory stage. After 2000, with the development of the mobile communication technology, it became possible to realize networking the machine devices by the mobile communication technology. The M2M service appeared in the market in about 2002 and developed rapidly in the subsequent several years, and becomes the focus of the numerous communication device traders and the telecommunication operators. Now, the global machine quantity is much more than the people quantity, so the good market prospect of the M2M technology can be predicted.

The research on the M2M communication application scene indicates that providing the M2M communication in the mobile network has the potential market prospects. But the M2M communication has put forward a lot of new requirements to the system, in order to strengthen the competitiveness of the mobile network in this respect, it is necessary to optimize the current mobile network to support the M2M communication more effectively.

The current mobile communication network is designed mainly aiming at the human to human communication, and the optimization on the communication of the machine to machine, the human to machine is insufficient. In addition, how can the operator provide the M2M communication service with the low cost is the key to success of the M2M communication deployment.

Because of the above-mentioned situations, it is necessary to research the solution for the mobile network to support the M2M communication, and the solution should reuse the current network to a high limit and reduce the influence to the network caused by a large number of the M2M communication and the complexity of the operation maintenance. The competition of the telecommunication market is becoming intense gradually at present, the expense is dropping constantly, the profit space of the operator is being reduced constantly, the communication market based on people is tending to the saturation, and the M2M communication is a brand-new development opportunity for the operator.

In order to utilize the mobile network resource efficiently, the 3rd Generation Partnership Project (3GPP) proposes the machine type communication (MTC), that is, the service of the M2M and the machine to man communication, of which the service scope has far gone beyond the communication between Human to Human (H2H) in the past, and the MTC has very great difference at the respects such as access control, charging, security, quality of service (QoS), the service mode, etc., with the current H2H communication mode.

FIG. 1 is a framework diagram of a 3GPP Evolved Packet System (EPS) in the related art. As shown in FIG. 1, the EPS includes a wireless access network and a core network, the wireless access network can be a Universal Terrestrial Radio Access Network (UTRAN), an Evolved UTRAN (E-UTRAN), a GSM or EDGE radio access network (GERAN). In the Evolved Packet Core (EPC), the core network can be a network element, such as, a Mobility Management Entity (MME), a Serving Gateway (S-GW), a Packet Data Network Gateway (P-GW), etc.; in the GPRS core network, the core network can be a network element, such as, a Serving GPRS Support Node (SGSN), etc.; in the E-UTRAN, the core network can be an evolved Node B (eNB).

The Small Data is one of the Features of the MTC, the problem that this feature pays close attention to is that: as to some MTC devices, their transmitted data bulk are very small, but the whole signaling procedure is still required, and the transmitted data and the involved signaling are asymmetric, which causes the waste of the network resource; moreover, because the quantity of the MTC devices is often very large, the concentrated access must bring a large number of signaling, which is very easy to cause the network congestion, so, it needs to adopt more effective way to transmit the Small Data.

The mall Data includes the Mobile Originated (MO) service and the Mobile Terminating (MT) service, that is, includes that the MTC device transmits the information or receives the information.

In order to realize the effective transmission of the Small Data, the scheme already put forward includes: transmitting the Small Data through the short message, or bearing the Small Data through the control plane signaling. FIG. 2 is the framework diagram of the MTC in the 3GPP in the related art. As shown in FIG. 2, as to the way of bearing the Small Data through the control plane signaling, the associated control plane signaling is transmitted to the network node, the network node retrieves the Small Data in the control plane signaling, and then transmits to the corresponding user equipment or other network nodes or the MTC server.

It is found that there are the following problems in the effective transmission of the Small Data during the research and practice of the related art: if the control plane signaling received by the network node which is responsible for processing the control plane signaling contains the user plane data, the network node may be unable to distinguish the conventional control plane signaling and the control plane signaling containing the user plane data, thus the control plane signaling containing the user plane data is processed incorrectly, which causes the loss of the user plane data.

### SUMMARY OF THE INVENTION

On that basis, the main objective of the present invention is to provide a method, system and apparatus for indicating a message type, so as to solve the problem that the user plane data are lost when the control plane signaling contains the user plane data.

In order to achieve the above-mentioned objective, the technical scheme of the present invention is realized like this:

the present invention provides a method for indicating a message type, comprising: setting a message type identification in a transmitted control plane signaling; and further comprising:

a network node which receives the control plane signaling, according to the message type identification, identifying whether user plane data are contained in the control plane signaling, and transmitting the user plane data to a user equipment or other network nodes or a machine type communication server (MTC Server) through the control plane signaling when confirming that the control plane signaling contains the user plane data; and

the user equipment or the MTC Server identifying whether the control plane signaling contains the user plane data, and retrieving the user plane data therefrom when the control plane signaling contains the user plane data.

In the above-mentioned method, the method further comprises:

when confirming that the control plane signaling does not contain the user plane data, the network node forwarding the control plane signaling not containing the user plane data to a corresponding user equipment, or other network nodes or the MTC Server.

In the above-mentioned method, the setting a message type identification in a transmitted control plane signaling is that:

the user equipment and/or the network node and/or the MTC Server adds a message type identification in a transmitted control plane signaling; wherein, the control plane signaling is a control plane signaling containing the user plane data, or a conventional control plane signaling.

In the above-mentioned method, the user equipment is a UE, a mobile equipment (ME), or a mobile station (MS); and

the network node is an evolved node B (eNB), a mobility management entity (MME), a serving GPRS support node (SGSN), a packet data network gateway (P-GW), a Gateway GPRS Support Node (GGSN), or an MTC interworking function (MTC-IWF).

In the above-mentioned method, the control plane signaling is a non access stratum signaling sent to the MME or the SGSN by the user equipment, or a NAS signaling sent to the user equipment by the MME or the SGSN, or the control plane signaling sent to the MME or the SGSN by the P-GW or the GGSN or the MTC-IWF, etc., or the control plane signaling sent to the MME or the SGSN or the MTC Server by the MTC-IWF, or the control plane signaling sent to the MME or the SGSN or the MTC Server by the P-GW or the GGSN, or the control plane signaling sent to the MTC-IWF or the P-GW or the GGSN by the MTC Server.

In the above-mentioned method, the message type identification is a message type indication bit.

In the above-mentioned method, the network node which receives the control plane signaling identifying whether user plane data are contained in the control plane signaling according to the message type identification is:

when the message type indication bit is 1, it is indicated that the control plane signaling contains the user plane data; when being 0, it is indicated that the control plane signaling does not contain the user plane data;

or, when the message type indication bit is 0, it is indicated that the control plane signaling containing the user plane data; when being 1, it is indicated that the control plane signaling does not contain the user plane data;

or, when the message type identification exists in the transmitted control plane signaling, it is indicated that the control plane signaling contains the user plane data; when the message type identification does not exist in the transmitted control plane signaling, it is indicated that the control plane signaling does not contain the user plane data.

In the above-mentioned method, the transmitting the user plane data to the user equipment or other network nodes or the MTC Server through the control plane signaling is:

the network node retrieving the user plane data from the control plane signaling containing the user plane data, and encapsulating the user plane data and the message type identification in the control plane signaling, and transmitting the control plane signaling to the user equipment, or other network nodes, or the MTC Server.

In the above-mentioned method, the MTC Server identifying whether the control plane signaling contains the user plane data, and retrieving the user plane data therefrom when the control plane signaling contains the user plane data is:

when the control plane signaling is an MO signaling, the user equipment or the network node forwarding the control plane signaling containing the user plane data to the corresponding network node, the corresponding network node forwarding the received control plane signaling to the MTC Server, and the MTC Server, according to the message type identification therein, identifying whether the control plane signaling contains the user plane data, when the control plane signaling contains the user plane data, analyzing the user plane data from the received control plane signaling.

In the above-mentioned method, the user equipment identifying whether the control plane signaling contains the user plane data, and retrieving the user plane data therefrom when the control plane signaling contains the user plane data is:

when the control plane signaling is an MT signaling, the MTC server or the network node forwarding the control plane signaling containing the user plane data to other network nodes, other network nodes forwarding control plane data to the user equipment, and the user equipment, according to the message type identification therein, identifying whether the control plane signaling contains the user plane data, when the control plane signaling contains the user plane data, retrieving the user plane data from the control plane signaling.

The present invention further provides a system for indicating a message type, comprising: a user equipment, a network node and a machine type communication server (MTC server); wherein,

the user equipment and/or the network node and/or the MTC server is configured to set a message type identification in a transmitted control plane signaling;

the network node is further configured to, according to the message type identification, identify whether user plane data are contained in the control plane signaling, and transmit the user plane data to the user equipment or other network nodes or the MTC Server through the control plane signaling when confirming that the control plane signaling contains the user plane data; and

the user equipment or the MTC Server is further configured to identify whether the control plane signaling contains the user plane data, and retrieves the user plane data therefrom when the control plane signaling contains the user plane data.

In the above-mentioned system, the network node is further configured to forward the control plane signaling not containing the user plane data to a corresponding user equipment or other network nodes or the MTC Server when confirming that the control plane signaling does not contain the user plane data.

The present invention further provides a user equipment, configured to set a message type identification in a transmitted control plane signaling, and further configured to receive the control plane signaling transmitted by a network node, identify whether the control plane signaling contains the user plane data, and retrieves the user plane data therefrom when the control plane signaling contains the user plane data.

The present invention further provides a network node, configured to set a message type identification in a transmitted control plane signaling, and further configured to according to the message type identification, identify whether user plane data are contained in the control plane signaling, and transmit the user plane data to the user equipment or other network nodes or the MTC Server through the control plane signaling when confirming that the control plane signaling contains the user plane data.

The network node is further configured to forward the control plane signaling not containing the user plane data to a corresponding user equipment or other network nodes or an MTC Server when confirming that the control plane signaling does not contain the user plane data.

The present invention further provides a machine type communication server (MTC server), configured to set a message type identification in a transmitted control plane signaling; and

further configured to receive the control plane signaling transmitted by a network node, identify whether the control plane signaling contains user plane data, and retrieves the user plane data therefrom when the control plane signaling contains the user plane data.

By the method, system and apparatus for indicating a message type provided in the present invention, a message type identification is set in a transmitted control plane signaling, it is identified whether user plane data are contained in the control plane signaling, and the network node receiving the control plane signaling transmits the user plane data to a user equipment or other network nodes or the MTC Server through the control plane signaling when confirming that the control plane signaling contains the user plane data according to the message type identification; and the user equipment or the MTC Server identifies whether the control plane signaling contains the user plane data, and retrieves the user plane data therefrom when the control plane signaling contains the user plane data, which is used to solve the problem that the user plane data are lost when the control plane signaling contains the user plane data and realizes the correct transmission of the user plane data borne through the control plane signaling.

### BRIEF DESCRIPTION OF DRAWINGS

FIG. 1 is a framework diagram of a 3GPP EPS in the related art.

FIG. 2 is a framework diagram of an MTC in the 3GPP in the related art.

FIG. 3 is a flow chart of a method of realizing indicating a message type of the present invention.

FIG. 4 is a flow chart of embodiment one of a method of realizing indicating a message type of the present invention.

FIG. 5 is a flow chart of embodiment two of a method of realizing indicating a message type of the present invention.

FIG. 6 is a structure diagram of a system of realizing indicating a message type of the present invention.

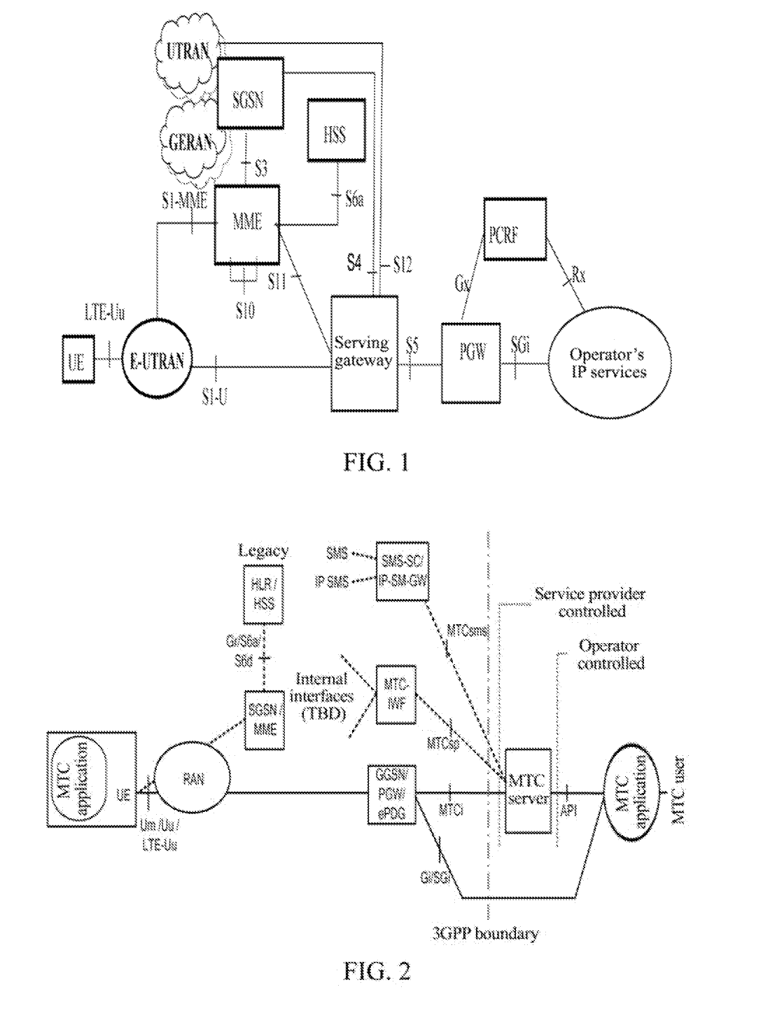

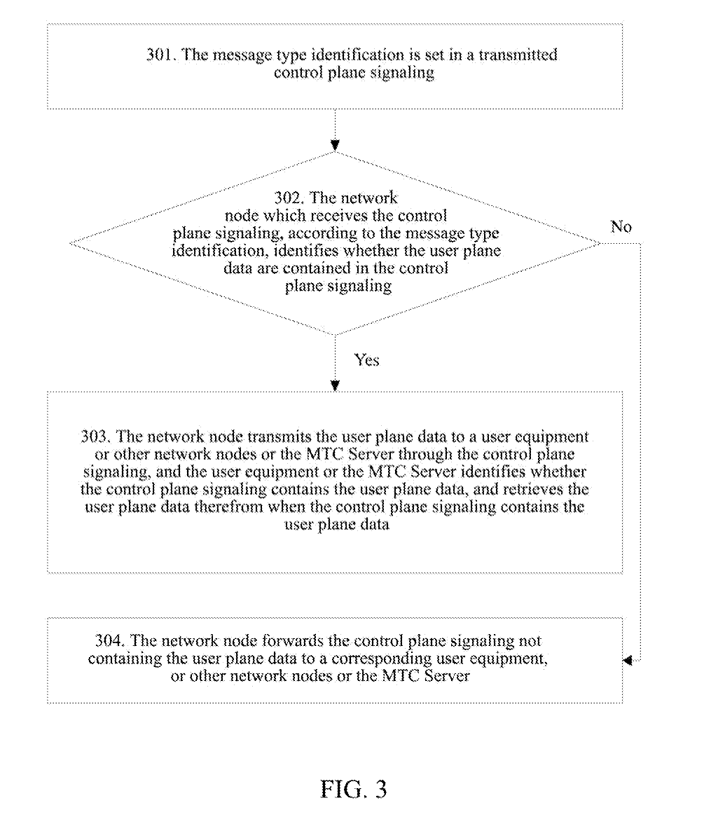

### PREFERRED EMBODIMENTS OF THE PRESENT INVENTION

The basic idea of the present invention is: setting a message type identification in a transmitted control plane signaling; a network node which receives the control plane signaling, according to the message type identification, identifying whether user plane data are contained in the control plane signaling, and transmitting the user plane data to a user equipment or other network nodes or a machine type communication server (MTC Server) through the control plane signaling when confirming that the control plane signaling contains the user plane data; and the user equipment or the MTC Server identifying whether the control plane signaling contains the user plane data, and retrieving the user plane data therefrom when the control plane signaling contains the user plane data.

The present invention is described in detail with reference to the accompanying drawings and in combination with embodiments hereinafter.

The present invention provides a method for indicating a message type, and FIG. 3 is a flow chart of the method of realizing indicating a message type of the present invention. As shown in FIG. 3, the method includes the following steps.

In step 301, a message type identification is set in a transmitted control plane signaling.

Specifically, the user equipment and/or the network node and/or the MTC Server adds a message type identification in a transmitted control plane signaling.

The control plane signaling is a control plane signaling containing the user plane data, or a conventional control plane signaling; and the user plane data are the Small Data in the MTC characteristics.

The user equipment can be a UE, a mobile equipment (ME), and a mobile station (MS); and the user equipment is also configured with the function supporting the MTC characteristics; the network node can be an evolved node B (eNB), a mobility management entity (MME), a serving GPRS support node (SGSN), a packet data network gateway (P-GW), a Gateway GPRS Support Node (GGSN), or an MTC interworking function (MTC-IWF).

The control plane signaling is a non access stratum signaling sent to the MME or the SGSN by the user equipment, or a NAS signaling sent to the user equipment by the MME or the SGSN, or the control plane signaling sent to the MME or the SGSN by the P-GW or the GGSN or the MTC-IWF, etc., or the control plane signaling sent to the MME or the SGSN or the MTC Server by the MTC-IWF, or the control plane signaling sent to the MME or the SGSN or the MTC Server by the P-GW or the GGSN, or the control plane signaling sent to the MTC-IWF or the P-GW or the GGSN by the MTC Server; wherein, the MME or SGSN sends the NAS signaling to the UE through the eNB.

In the present invention, the message type identification added in the transmitted control plane signaling can be a message type indication bit; when the message type indication bit is 1, it is indicated that the control plane signaling contains the user plane data; when the message type indication bit is 0, it is indicated that the control plane signaling does not contain the user plane data; or, when the message type indication bit is 0, it is indicated that the control plane signaling contains the user plane data; when the message type indication bit is 1, it is indicated that the control plane signaling does not contain the user plane data; or, the message type identification is only added in the control plane signaling containing the user plane data, that is, when the message type identification exists in the transmitted control plane signaling, it is indicated that the control plane signaling contains the user plane data; when the message type identification does not exist in the transmitted control plane signaling, it is indicated that the control plane signaling does not contain the user plane data.

In step 302, the network node which receives the control plane signaling, according to the message type identification, identifies whether the user plane data are contained in the control plane signaling, and if yes, then step 303 is executed; or else, step 304 is executed.

In step 303, the network node transmits the user plane data to a user equipment or other network nodes or the MTC Server through the control plane signaling; and the user equipment or the MTC Server identifies whether the control plane signaling contains the user plane data, and retrieves the user plane data therefrom when the control plane signaling contains the user plane data.

Specifically, the network node retrieves the user plane data from the control plane signaling containing the user plane data, and encapsulates the user plane data and the message type identification in the control plane signaling, and transmits the control plane signaling to the user equipment, or other network nodes, or the MTC Server.

if the network node is a network node close to the user equipment or the MTC Server, then the user plane data do not need to be forwarded through other network nodes; if the network node is not a network node close to the user equipment or the MTC Server, the user plane data need to be further forwarded through other network nodes, and the operation of the other network nodes receiving the control plane signaling is the same as the operation in step 302 and step 303.

Finally, the control plane signaling will reach the user equipment or the MTC Server, and after the user equipment or the MTC Server receives the control plane signaling, according to the message type identification therein, the user equipment or the MTC Server identifies whether the control plane signaling contains the user plane data, and when the control plane signaling contains the user plane data, the user equipment or the MTC Server analyzes the control plane signaling, and obtains the user plane data.

Here, if the control plane signaling is an MO signaling, the user equipment or the network node MME or SGSN may not retrieve the user plane data from the control plane signaling containing the user plane data but forward the control plane signaling containing the user plane data to the corresponding network node, such as, the P-GW or GGSN or MTC IWF etc., and the P-GW or GGSN or MTC IWF forwards the received control plane signaling to the MTC Server, and the MTC Server identifies whether the control plane signaling contains the user plane data, and when the control plane signaling contains the user plane data, retrieves the user plane data from the received control plane signaling.

If the control plane signaling is an MT signaling, the MTC server or the network node MTC-IWF or P-GW or GGSN may not retrieve the user plane data from the control plane signaling containing the user plane data but forward the control plane signaling containing the user plane data to other network nodes, MME or SGSN, the MME or SGSN forwards the control plane data to the user equipment, and the user equipment identifies whether the control plane signaling contains the user plane data, and when the control plane signaling contains the user plane data, retrieves the user plane data from the control plane signaling.

In step 304, the network node forwards the control plane signaling not containing the user plane data to a corresponding user equipment, or other network nodes or the MTC Server.

### Embodiment One

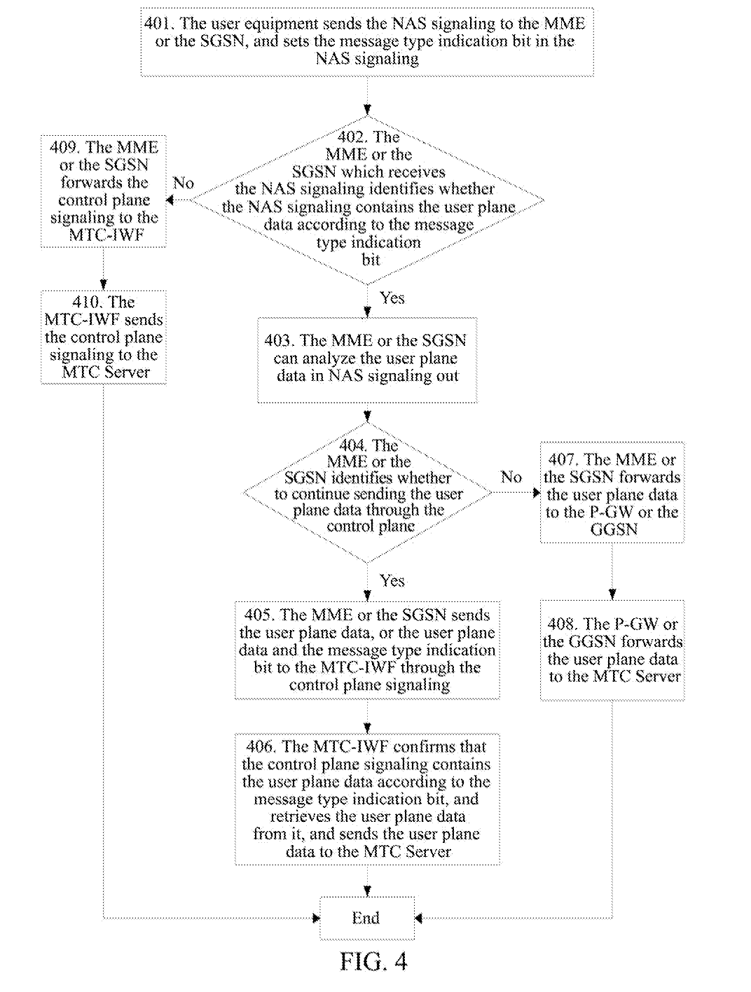

FIG. 4 is a flow chart of embodiment one of a method of realizing indicating a message type of the present invention, and this flow is for the scenario of the user equipment initiating an MO signaling. As shown in FIG. 4, the method includes the following steps.

In step 401, the user equipment sends the NAS signaling to the MME or the SGSN, and sets the message type indication bit in the NAS signaling.

Specifically, the user equipment sends the NAS signaling to the MME or the SGSN, and adds a message type indication bit in the NAS signaling; the NAS signaling can be a NAS signaling sent by the user equipment in any of the following signaling processes: Attach Request, Service Request, TAU/RAU Request, etc.; the NAS signaling includes the user plane data, Small Data; the size of the Small Data is generally given by the user signing data or the Operation and Maintenance entity (O&M) of the operator or the MTC Server.

The message type indication bit is one bit, when the bit is 1 or 0 or exists, it is indicated that the control plane signaling contains the user plane data, and when the bit is 0 or 1 or does not exist, it is indicated that the control plane signaling does not contain the user plane data. It can be identified whether the control plane signaling contains the user plane data according to the value of the bit or whether the bit exists.

In step 402, the MME or the SGSN which receives the NAS signaling identifies whether the NAS signaling contains the user plane data according to the message type indication bit; if yes, then step 403 is executed, otherwise, step 409 is executed.

Here, the MME or the SGSN, after receiving the NAS signaling, checks the message type indication bits at first, and identifies whether the NAS signaling contains the user plane data.

In step 403, the MME or the SGSN analyzes the user plane data in NAS signaling out.

Specifically, the MME or the SGSN analyzes the user plane data in the NAS signaling out according to the protocol.

In step 404, the MME or the SGSN identifies whether to continue sending the user plane data through the control plane, if yes, step 405 is executed, otherwise, step 407 is executed.

Specifically, the MME or SGSN identifies by itself or identifies according to the instructions of the O&M whether to continue sending the user plane data through the control plane or the user plane, if yes, step 405 is executed, otherwise, step 407 is executed.

In step 405, the MME or the SGSN sends the user plane data, or the user plane data and the message type indication bit to the MTC-IWF through the control plane signaling.

Specifically, the MME or the SGSN encapsulates the user plane data, or the user plane data and the message type indication bit in the control plane signaling, and sends this control plane signaling to the MTC-IWF; the control plane signaling is a control plane signaling between the MME or the SGSN and the MTC-IWF.

In step 406, the MTC-IWF confirms that the control plane signaling contains the user plane data according to the message type indication bit, and retrieves the user plane data from it, and sends the user plane data to the MTC Server, and the flow ends.

Specifically, the MTC-IWF is a control plane network node, the MTC-IWF confirms that the control plane signaling contains the user plane data according to the message type indication bit, and retrieves the user plane data from it, encapsulates again the user plane data or the user plane data and the message type indication bit in the control plane signaling and sends to the MTC Server, the control plane signaling is the control plane signaling between the MTC-IWF and the MTC Server; and the MTC Server retrieves the user plane data from the received control plane signaling.

In step 407, the MME or the SGSN forwards the user plane data to the P-GW or the GGSN.

Specifically, the MME forwards the user plane data to the P-GW, or the SGSN forwards the user plane data to the P-GW or the GGSN; generally there is no direct interface between the MME or the SGSN and the P-GW, the MME or the SGSN can forward the user plane data to the P-GW through the S-GW, or the SGSN forwards the user plane data to the GGSN directly.

In step 408, the P-GW or the GGSN forwards the user plane data to the MTC Server, and the flow ends.

In step 409, the MME or the SGSN forwards the control plane signaling to the MTC-IWF.

Specifically, there is no user plane data in the control plane signaling, the MME or the SGSN finds the corresponding MTC-IWF through the indication of the control plane signaling or through querying the registration information in the Home Subscriber Server (HSS) or the Home Location Register (HLR), and forwards the control plane signaling to the MTC-IWF.

In step 410, the MTC-IWF sends the control plane signaling to the MTC Server, and the flow ends.

Here, the MTC-IWF finds corresponding MTC Server through the control plane signaling indication or through the registration information in the HSS or the HLR, and forwards the control plane signaling to the MTC Server.

### Embodiment 2

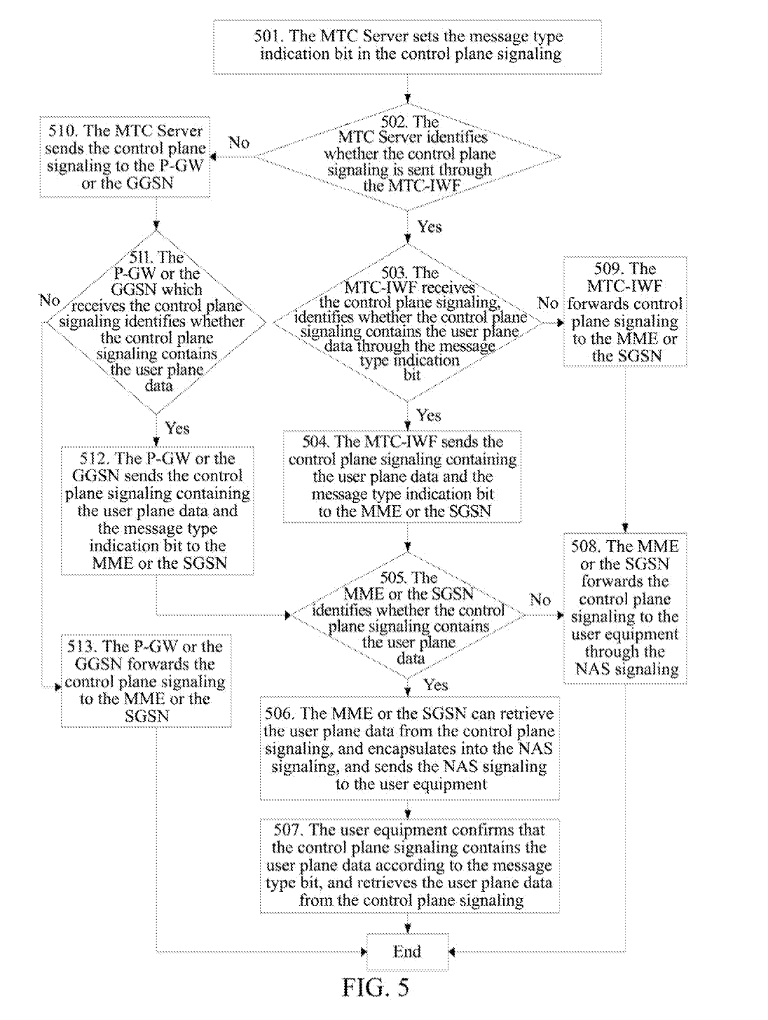

FIG. 5 is a flow chart of embodiment two of a method of realizing indicating a message type of the present invention, and this flow is for the scenario of the network side initiating an MT signaling. As shown in FIG. 5, the method includes the following steps.

In step 501, the MTC Server sets the message type indication bit in the control plane signaling; wherein, the control plane signaling refers to the signaling between the MTC Server and the P-GW, the GGSN or the MTC-IWF.

In step 502, the MTC Server identifies whether the control plane signaling is sent through the MTC-IWF, if yes, step 503 is executed, otherwise, step 510 is executed.

Specifically, the MTC Server can identify by itself or identify according to the instructions of the O&M whether the control plane signaling is sent through the MTC-IWF; if yes, step 503 is executed, otherwise, step 510 is executed.

In step 503, the MTC-IWF receives the control plane signaling, identifies whether the control plane signaling contains the user plane data through the message type indication bit, if yes, step 504 is executed; otherwise, step 509 is executed.

In step 504, the MTC-IWF sends the control plane signaling containing the user plane data and the message type indication bit to the MME or the SGSN.

Specifically, the MTC-IWF retrieves the user plane data, and then encapsulates the user plane data and the message type indication bit into the new control plane signaling; the control plane signaling refers to the control plane signaling between the MTC-IWF and the MME or the SGSN; the MTC-IWF queries the corresponding MME or SGSN according to the instruction of control plane signaling or the signing data in the HSS or the HLR, and sends the control plane signaling to the MME or the SGSN.

In step 505, the MME or the SGSN identifies whether the control plane signaling contains the user plane data, and if yes, step 506 is turned to, otherwise step 508 is turned to.

In step 506, the MME or the SGSN retrieves the user plane data from the control plane signaling, and encapsulates into the NAS signaling, and after adding the message class bit in the NAS signaling, sends the NAS signaling to the user equipment.

In step 507, the user equipment confirms that the control plane signaling contains the user plane data according to the message type bit, the user equipment retrieves the user plane data from the control plane signaling, and the flow ends; wherein, the user equipment retrieves the user plane data from the control plane signaling according to the stipulation of the protocol.

In step 508, the MME or the SGSN forwards the control plane signaling to the user equipment through the NAS signaling, and flow ends.

In step 509, the MTC-IWF forwards control plane signaling to the MME or the SGSN, and step 508 is executed.

In step 510, the MTC Server sends the control plane signaling to the P-GW or the GGSN; wherein, the control plane signaling is the control plane signaling in which the message type indication bit is added.

In step 511, the P-GW or the GGSN which receives the control plane signaling identifies whether the control plane signaling contains the user plane data through the message type bit, if yes, step 512 is executed, otherwise, step 513 is executed.

In step 512, the P-GW or the GGSN sends the control plane signaling containing the user plane data and the message type indication bit to the MME or the SGSN, and step 505 is executed; here, generally there is no direct interface between the P-GW and the MME or the SGSN, the P-GW can forward the signaling to the MME or the SGSN through the S-GW, or the GGSN forwards the signaling to the SGSN directly.

In step 513, the P-GW or the GGSN forwards the control plane signaling to the MME or the SGSN, and step 508 is executed.

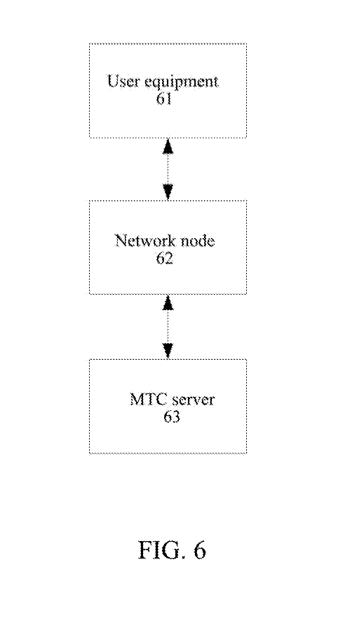

In order to realize the above-mentioned method, the present invention further provides a system for indicating a message type, and FIG. 6 is a structure diagram of a system of realizing indicating a message type of the present invention. As shown in FIG. 6, the system includes a user equipment 61, a network node 62 and a machine type communication server (MTC server) 63; wherein,

the user equipment 61 and/or the network node 62 and/or the MTC server 63 is configured to set a message type identification in a transmitted control plane signaling;

the network node 62 is further configured to, according to the message type identification, identify whether user plane data are contained in the control plane signaling, and transmit the user plane data to the user equipment 61 or other network nodes 62 or the MTC Server 63 through the control plane signaling when confirming that the control plane signaling contains the user plane data; and

the user equipment 61 or the MTC Server 63 is further configured to identify whether the control plane signaling contains the user plane data, and retrieves the user plane data therefrom when the control plane signaling contains the user plane data.

The network node 62 is further configured to forward the control plane signaling not containing the user plane data to a corresponding user equipment 61 or other network nodes or the MTC Server 63 when confirming that the control plane signaling does not contain the user plane data.

The control plane signaling is a control plane signaling containing the user plane data, or a conventional control plane signaling.

The user equipment is a UE, a mobile equipment (ME), or a mobile station (MS); and the network node is an evolved node B (eNB), a mobility management entity (MME), a serving GPRS support node (SGSN), a packet data network gateway (P-GW), a Gateway GPRS Support Node (GGSN), or an MTC interworking function (MTC-IWF).

The control plane signaling is a non access stratum signaling sent to the MME or the SGSN by the user equipment, or a NAS signaling sent to the user equipment by the MME or the SGSN, or the control plane signaling sent to the MME or the SGSN by the P-GW or the GGSN or the MTC-IWF, etc., or the control plane signaling sent to the MME or the SGSN or the MTC Server by the MTC-IWF, or the control plane signaling sent to the MME or the SGSN or the MTC Server by the P-GW or the GGSN, or the control plane signaling sent to the MTC-IWF or the P-GW or the GGSN by the MTC Server.

The message type identification is a message type indication bit.

The network node 62 which receives the control plane signaling identifying whether user plane data are contained in the control plane signaling according to the message type identification is: when the message type indication bit is 1, it is indicated that the control plane signaling contains the user plane data; when being 0, it is indicated that the control plane signaling does not contain the user plane data; or, when the message type indication bit is 0, it is indicated that the control plane signaling contains the user plane data; when being 1, it is indicated that the control plane signaling does not contain the user plane data; or, when the message type identification exists in the transmitted control plane signaling, it is indicated that the control plane signaling contains the user plane data; when the message type identification does not exist in the transmitted control plane signaling, it is indicated that the control plane signaling does not contain the user plane data.

The network node 62 transmitting the user plane data to the user equipment 61 or other network nodes or the MTC Server 63 through the control plane signaling is: the network node retrieving the user plane data from the control plane signaling containing the user plane data, and encapsulating the user plane data and the message type identification in the control plane signaling, and transmitting the control plane signaling to the user equipment, or other network nodes, or the MTC Server.

The MTC Server 63 identifying whether the control plane signaling contains the user plane data, and retrieving the user plane data therefrom when the control plane signaling contains the user plane data is: when the control plane signaling is an MO signaling, the user equipment or the network node forwarding the control plane signaling containing the user plane data to the corresponding network node, the corresponding network node forwarding the received control plane signaling to the MTC Server, and the MTC Server, according to the message type identification therein, identifying whether the control plane signaling contains the user plane data, when the control plane signaling contains the user plane data, analyzing the user plane data from the received control plane signaling.

The user equipment 61 identifying whether the control plane signaling contains the user plane data, and retrieving the user plane data therefrom when the control plane signaling contains the user plane data is: when the control plane signaling is an MT signaling, the MTC server or the network node forwarding the control plane signaling containing the user plane data to other network nodes, other network nodes forwarding control plane data to the user equipment, and the user equipment, according to the message type identification therein, identifying whether the control plane signaling contains the user plane data, when the control plane signaling contains the user plane data, analyzing the user plane data from the received control plane signaling.

The above description is only the embodiments of the present invention and is not intended to limit the protective scope of the present invention. Any modifications, equivalents and/or variations without departing from the spirit and essence of the present invention should be embodied in the scope of the appending claims of the present invention.

What we claim is:

1. A method for indicating a message type, comprising: setting a message type identification in a transmitted control plane signaling; and further comprising:
a network node which receives the control plane signaling, according to the message type identification, identifying whether user plane data are contained in the control plane signaling, and transmitting the user plane data to a user equipment or other network nodes or a machine type communication server (MTC Server) through the control plane signaling when confirming that the control plane signaling contains the user plane data;
the user equipment or the MTC Server identifying whether the control plane signaling contains the user plane data, and retrieving the user plane data when the control plane signaling contains the user plane data.

2. The method according to claim 1, further comprising:
when confirming that the control plane signaling does not contain the user plane data, the network node forwarding the control plane signaling not containing the user plane data to a corresponding user equipment, or other network nodes or the MTC Server.

3. The method according to claim 1, wherein, the setting a message type identification in a transmitted control plane signaling is that:
the user equipment and/or the network node and/or the MTC Server adds a message type identification in a transmitted control plane signaling; wherein, the control plane signaling is a control plane signaling containing the user plane data, or a conventional control plane signaling.

4. The method according to claim 1, wherein,
the user equipment is a UE, a mobile equipment (ME), or a mobile station (MS);
the network node is an evolved node B (eNB), a mobility management entity (MME), a serving GPRS support node (SGSN), a packet data network gateway (P-GW), a Gateway GPRS Support Node (GGSN), or an MTC interworking function (MTC-IWF).

5. The method according to claim 1, wherein, the control plane signaling is a non access stratum signaling sent to the MME or the SGSN by the user equipment, or a NAS signaling sent to the user equipment by the MME or the SGSN, or the control plane signaling sent to the MME or the SGSN by the P-GW or the GGSN or the MTC-IWF, etc., or the control plane signaling sent to the MME or the SGSN or the MTC Server by the MTC-IWF, or the control plane signaling sent to the MME or the SGSN or the MTC Server by the P-GW or the GGSN, or the control plane signaling sent to the MTC-IWF or the P-GW or the GGSN by the MTC Server.

6. The method according to claim 1, wherein, the message type identification is a message type indication bit.

7. The method according to claim 6, wherein, the network node which receives the control plane signaling identifying whether user plane data are contained in the control plane signaling according to the message type identification is:
when the message type indication bit is 1, it is indicated that the control plane signaling contains the user plane data; when being 0, it is indicated that the control plane signaling does not contain the user plane data;
or, when the message type indication bit is 0, it is indicated that the control plane signaling contains the user plane data; when being 1, it is indicated that the control plane signaling does not contain the user plane data;
or, when the message type identification exists in the transmitted control plane signaling, it is indicated that the control plane signaling contains the user plane data; when the message type identification does not exist in the transmitted control plane signaling, it is indicated that the control plane signaling does not contain the user plane data.

8. The method according to claim 1, wherein, the transmitting the user plane data to the user equipment or other network nodes or the MTC Server through the control plane signaling is:
the network node retrieving the user plane data from the control plane signaling containing the user plane data, and encapsulating the user plane data and the message type identification in the control plane signaling, and transmitting the control plane signaling to the user equipment, or other network nodes, or the MTC Server.

9. The method according to claim 1, wherein, the MTC Server identifying whether the control plane signaling contains the user plane data, and retrieving the user plane data when the control plane signaling contains the user plane data is:
when the control plane signaling is an MO signaling, the user equipment or the network node forwarding the control plane signaling containing the user plane data to the corresponding network node, the corresponding network node forwarding the received control plane signaling to the MTC Server, and the MTC Server, according to the message type identification in the control plane signaling, identifying whether the control plane signaling contains the user plane data, when the control plane signaling contains the user plane data, retrieving the user plane data from the received control plane signaling.

10. The method according to claim 1, wherein, the user equipment identifying whether the control plane signaling contains the user plane data, and retrieving the user plane data when the control plane signaling contains the user plane data is:
when the control plane signaling is an MT signaling, the MTC server or the network node forwarding the control plane signaling containing the user plane data to other network nodes, other network nodes forwarding control plane data to the user equipment, and the user equipment, according to the message type identification therein, identifying whether the control plane signaling contains the user plane data, when the control plane signaling contains the user plane data, retrieving the user plane data from the control plane signaling.

11. (canceled)

12. (canceled)

13. A user equipment, configured to set a message type identification in a transmitted control plane signaling, and further configured to receive the control plane signaling transmitted by a network node, identify whether the control plane signaling contains user plane data, and retrieve the user plane data when the control plane signaling contains the user plane data.

14. A network node, configured to set a message type identification in a transmitted control plane signaling, and further configured to, according to the message type identification, identify whether user plane data are contained in the control plane signaling, and transmit the user plane data to the user equipment or other network nodes or the MTC Server through the control plane signaling when confirming that the control plane signaling contains the user plane data.

15. The network node according to claim 14, further configured to forward the control plane signaling not containing the user plane data to a corresponding user equipment or other network nodes or an MTC Server when confirming that the control plane signaling does not contain the user plane data.

16. A machine type communication server (MTC server), configured to set a message type identification in a transmitted control plane signaling; and
further configured to receive the control plane signaling transmitted by a network node, identify whether the control plane signaling contains user plane data, and retrieves the user plane data therefrom when the control plane signaling contains the user plane data.

17. The method according to claim 2, wherein,
the user equipment is a UE, a mobile equipment (ME), or a mobile station (MS);
the network node is an evolved node B (eNB), a mobility management entity (MME), a serving GPRS support node (SGSN), a packet data network gateway (P-GW), a Gateway GPRS Support Node (GGSN), or an MTC interworking function (MTC-IWF).

18. The method according to claim 3, wherein,
the user equipment is a UE, a mobile equipment (ME), or a mobile station (MS);
the network node is an evolved node B (eNB), a mobility management entity (MME), a serving GPRS support node (SGSN), a packet data network gateway (P-GW), a Gateway GPRS Support Node (GGSN), or an MTC interworking function (MTC-IWF).

19. The method according to claim 2, wherein, the control plane signaling is a non access stratum signaling sent to the MME or the SGSN by the user equipment, or a NAS signaling sent to the user equipment by the MME or the SGSN, or the control plane signaling sent to the MME or the SGSN by the P-GW or the GGSN or the MTC-IWF, etc., or the control plane signaling sent to the MME or the SGSN or the MTC Server by the MTC-IWF, or the control plane signaling sent to the MME or the SGSN or the MTC Server by the P-GW or the GGSN, or the control plane signaling sent to the MTC-IWF or the P-GW or the GGSN by the MTC Server.

20. The method according to claim 3, wherein, the control plane signaling is a non access stratum signaling sent to the MME or the SGSN by the user equipment, or a NAS signaling sent to the user equipment by the MME or the SGSN, or the control plane signaling sent to the MME or the SGSN by the P-GW or the GGSN or the MTC-IWF, etc., or the control plane signaling sent to the MME or the SGSN or the MTC Server by the MTC-IWF, or the control plane signaling sent to the MME or the SGSN or the MTC Server by the P-GW or the GGSN, or the control plane signaling sent to the MTC-IWF or the P-GW or the GGSN by the MTC Server.
